(19) United States
(12) Patent Application Publication
(10) Pub. No.: US 2011/0025936 A1
(43) Pub. Date: Feb. 3, 2011

(54) Display Panel, Liquid Crystal Display Module, and Method for Reducing Data Lines Used on a Display Panel

(76) Inventors: Lun-Ming Chang, Taipei County (TW); Chia-Yi Lu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/625,578

(22) Filed: Nov. 25, 2009

(30) Foreign Application Priority Data
Jul. 31, 2009 (TW) 098125879

(51) Int. Cl. G09G 3/36; G02F 1/1368; G02F 1/1343

(52) U.S. Cl. 349/37; 349/42; 349/139

(57) ABSTRACT

On a display panel, every two neighboring sub-pixel transistor modules of each row transistor set are electrically coupled to a same data line so that used data lines on the display panel are halved, and driving integrated circuit units on the display panel are significantly decreased as well. A voltage on a data line of the display panel is controlled according to a polarity controlling signal to implement polarity inversion, for preventing DC residue and crosstalk, and for reducing power consumption and flickers. Two sub-pixel transistors of each transistor unit on the display panel are disposed in a mutually opposed and separated manner for overcoming vertical lines caused by concentrated transmittance of the sub-pixel transistors.

### BACKGROUND OF THE INVENTION

1. Field of the Invention

The present invention relates to a display panel having reduced data lines, a liquid crystal display module including the display panel, and a method for reducing used data lines on the display panel, and more particularly, to a display panel of electrically connecting two neighboring sub-pixel transistor modules of a same row transistor set with a same data line for reducing used data lines, a liquid crystal display module including the display panel, and a method of reducing used data lines of the display panel.

2. Description of the Prior Art

Please refer to FIG. 1, which is a schematic diagram of a conventional liquid crystal display module 100. The liquid crystal display module 100 includes a display panel 110, a scan driving unit 120, a data driving unit 130, a timing controller 140, a reference voltage source 150, a backlight driving unit 160, and a backlight module 170. The timing controller 140 outputs data to the data driving unit 130, and outputs a control signal to the scan driving unit for controlling transistors and pixel electrodes of the display panel 110. Power of the scan driving unit 120 and the data driving unit 130 is provided by the reference voltage source 150. Lights of the display panel 110 are provided by the backlight module 170, which is controlled by the backlight driving unit 160. A plurality of data lines of the data driving unit 130 are indicated by Sn, and a plurality of gate lines of the scan driving unit 120 are indicated by Gn. While a certain transistor on the display panel 110 and a pixel electrode electrically connected to the certain transistor are to be activated, one of the plurality of gate lines Gn corresponding to the certain transistor is triggered by the scan driving unit 120, and one of the plurality of data lines Sn corresponding to the certain transistor receives a voltage, which indicates data transformed by the data driving unit 130, for charging/discharging the pixel electrode to a corresponding gray level.

Please refer to FIG. 2, which is a schematic diagram illustrating the display panel 110, the scan driving unit 120, and the data driving unit 130 shown in FIG. 1. As shown in FIG. 2, the display panel 110 displays sub-pixels indicating three different colors, i.e., red sub-pixels R, green sub-pixels G, and blue sub-pixels B. Suppose that there are 480*3*272 sub-pixels on the display panel 110, where the number 480*3 indicates 480 pixels on a same row of the display panel 110 multiplied by three sub-pixels of different colors, i.e., there are 1440 data lines Sn and corresponding driving integrated circuit units on the data driving unit 130, and where the number 272 indicates 272 rows of pixels on the display panel 110, i.e., there are 272 gate lines Gn and corresponding driving integrated circuit units on the scan driving unit 120. As can be observed from the above assumptions, for a single display panel 110, there must be 1440 driving integrated circuit units disposed in the data driving unit 130, and be 272 driving integrated circuit units disposed in the scan driving unit 120, so that the display panel 110 may display frames. However, under the trend of developing light-weighted display panels, a number of used driving integrated circuit units of a display panel is required to be reduced. Note that in a conventional display panel, a number of data lines is much more than a number of gate lines, and the above assumptions about numbers of gate lines and data lines used in a display panel are based on the mentioned fact.

### SUMMARY OF THE INVENTION

The claimed invention discloses a display panel. The display panel comprises a plurality of row transistor sets, a first gate line module, a second gate line module, and a plurality of data lines. The plurality of row transistor sets is arranged as a transistor matrix. Each of the plurality of row transistor sets is disposed on the transistor matrix row by row. Each of the plurality of row transistor sets comprising a plurality of odd sub-pixel transistor modules and a plurality of even sub-pixel transistor modules arranged in an alternative and respective correspondence with the plurality of odd-pixel transistor modules. The first gate line module comprises a plurality of first gate lines. Each of the plurality of first gate lines is respectively corresponding to the plurality of row transistor sets. Each of the plurality of first gate lines is electrically connected to a plurality of odd sub-pixel transistor modules comprised by one of the plurality of row transistor sets. The second gate line module comprises a plurality of second gate lines. Each of the plurality of second gate lines is respectively corresponding to the plurality of row transistor sets. Each of the plurality of second gate lines is electrically connected to a plurality of even sub-pixel transistor modules comprised by one of the plurality of row transistor sets. Each of the plurality of data lines is electrically connected to both an odd sub-pixel transistor module and an even sub-pixel transistor module of each of the plurality of row transistor sets. The odd and even sub-pixel transistor modules electrically connected to each of the plurality of data lines in a same row transistor module are next to each other to form a transistor unit.

The claimed invention discloses a method of reducing data lines used on a display panel. The disclosed method comprises electrically connecting a plurality of odd sub-pixel transistor modules and a plurality of even sub-pixel transistor modules respectively next to the plurality of odd sub-pixel transistor modules with a same data line to form a plurality of transistor units; electrically connecting an odd sub-pixel transistor module of each of a plurality of transistor units of each of the plurality of row transistor sets with a first gate line; electrically connecting an even sub-pixel transistor module of each of the plurality of transistor units of each of the plurality of row transistor sets with a second gate line; alternatively activating the first and second gate lines within an activate time of each of the plurality of row transistor sets; and providing a voltage on a data line, which is electrically connected to both the odd sub-pixel transistor module and the even sub-pixel transistor module, according to whether the first or second gate line is activated and according to a polarity control signal, for writing the provided voltage into the odd sub-pixel transistor module or the even sub-pixel transistor module. The plurality of odd and even sub-pixel transistor modules is comprised by each of a plurality of row transistor sets.

The claimed invention discloses a liquid crystal display module. The liquid crystal display module comprises a display panel, a scan driving unit, and a data driving unit. The display panel comprises a plurality of row transistor sets, a first gate line module, a second gate line module, and a plurality of data lines. The plurality of row transistor sets is arranged as a transistor matrix. Each of the plurality of row transistor sets is disposed on the transistor matrix row by row. Each of the plurality of row transistor sets comprises a plurality of odd sub-pixel transistor modules and a plurality of even sub-pixel transistor modules arranged in an alternative and respective correspondence with the plurality of odd-pixel transistor modules. The first gate line module comprises a plurality of first gate lines. Each of the plurality of first gate lines is respectively corresponding to the plurality of row transistor sets. Each of the plurality of first gate lines is electrically connected to a plurality of odd sub-pixel transistor modules comprised by one of the plurality of row transistor sets. The second gate line module comprises a plurality of second gate lines. Each of the plurality of second gate lines is respectively corresponding to the plurality of row transistor sets. Each of the plurality of second gate lines is electrically connected to a plurality of even sub-pixel transistor modules comprised by one of the plurality of row transistor sets. Each of the plurality of data lines is electrically connected to both an odd sub-pixel transistor module and an even sub-pixel transistor module of each of the plurality of row transistor sets. The scan driving unit is electrically connected to the first gate line module and the second gate line module. The scan driving unit is utilized for alternatively activating the first and second gate line modules, for alternatively driving the plurality of odd and even sub-pixel transistor modules of each of the row transistor sets and for performing polarity inversion. The data driving unit is electrically connected to the plurality of data lines. The data driving unit provides a voltage according to whether the first or second gate line is activated and according to a polarity control signal, for writing the provided voltage into the odd sub-pixel transistor module or the even sub-pixel transistor module to perform polarity inversion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional liquid crystal display module.

FIG. 2 is a schematic diagram illustrating the display panel, the scan driving unit, and the data driving unit shown in FIG. 1.

FIG. 3 is a schematic diagram of a liquid crystal display module according to an embodiment of the present invention.

FIG. 4 is a diagram of the display panel shown in FIG. 3 according to an embodiment of the present invention.

FIG. 5 is a diagram of a transistor unit of the display panel shown in FIG. 4.

FIG. 6 illustrates data transfer on the display panel shown in FIG. 3 and FIG. 4.

FIG. 7 is a waveform diagram related to the display panel shown in FIG. 3 and FIG. 4.

FIG. 8 illustrates the polarity inversion between two consecutively-displayed frames in a correspondence to the waveform diagram shown in FIG. 7.

FIG. 9, FIG. 10, and FIG. 11 are diagrams of transistor units used on the display panel of the present invention for preventing the vertical lines according to embodiments of the present invention.

FIG. 12 is a flowchart of a method of reducing data lines on a display panel according to an embodiment of the present invention.

### DETAILED DESCRIPTION

The present invention discloses a display panel for reducing used data lines, a liquid crystal display module including the display panel, and a method thereof. In the disclosed display panel, a data line is electrically connected to a pair of an odd sub-pixel transistor module and an even sub-pixel transistor module, both of which are controlled by gate lines to display odd/even pixels and to perform polarity inversion, so that used data lines and corresponding driving integrated circuit units may be reduced. Besides, odd/even sub-pixel transistors respectively included by the pair of odd and even sub-pixel transistor modules are disposed in a mutually opposed and separated manner so that transmittance of the sub-pixel transistors may be uniformly dispersed to neutralize a phenomenon called vertical lines, which may thereby be unapparent for an observer of the display panel.

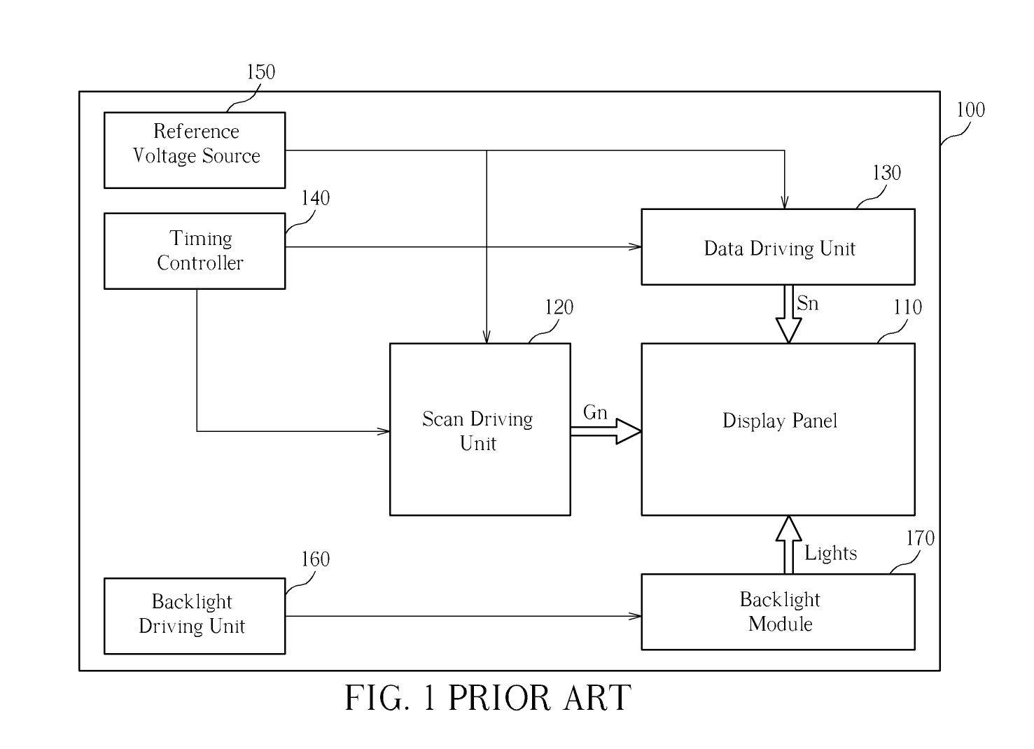

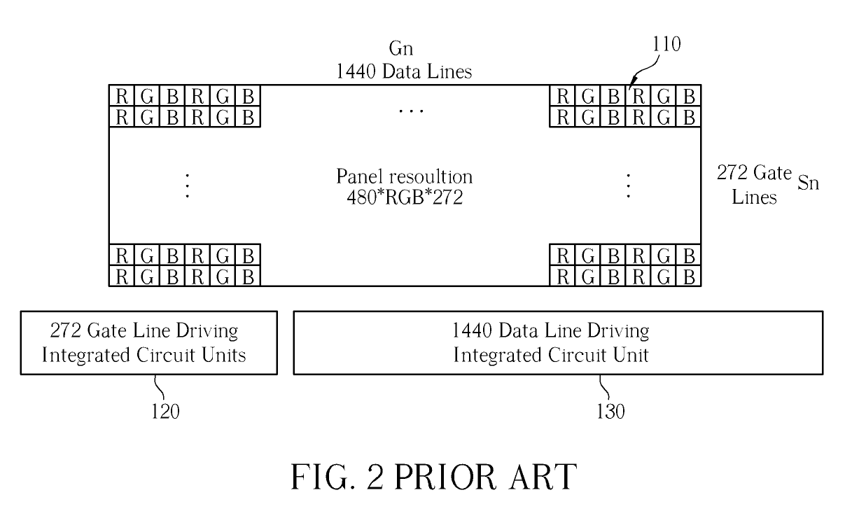

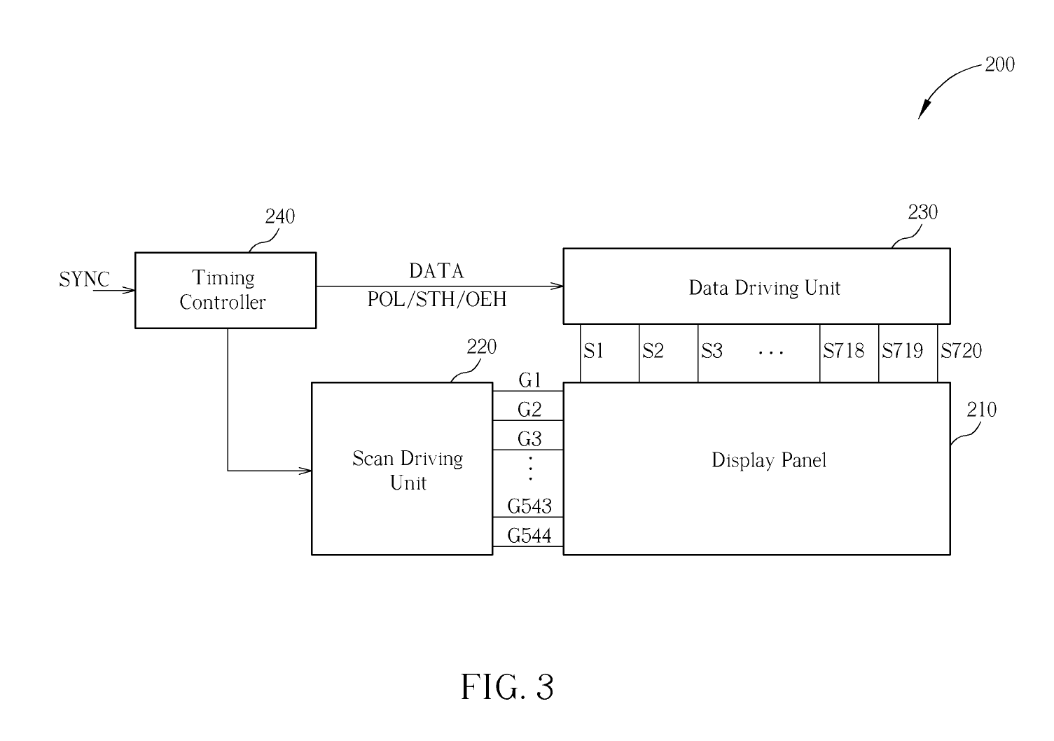

Please refer to FIG. 3, which is a schematic diagram of a liquid crystal display module 200 according to an embodiment of the present invention. As shown in FIG. 3, the liquid crystal display module 200 includes a display panel 210, a scan driving unit 220, a data driving unit 230, and a timing controller 240. The display panel 210 has a same amount of sub-pixel transistors with the display panel 110 shown in FIG. 1, but merely has 720 data lines S1, S2, S3, . . . , S718, S719, S720, i.e., has a half amount of the data lines Sn shown in FIG. 2. Besides, there are 544 gate lines G1, G2, G3, . . . , G543, G544 between the display panel 210 and the scan driving unit 220, i.e., a double amount of gate lines Gn shown in FIG. 2. Though in comparison of the display panel 110 shown in FIG. 2, there are a double amount of gate lines in the display panel 210, but there are also a half amount of data lines in the display panel 210 so that a required amount of lines used in the display panel 210 is reduced in total. In other words, required driving integrated circuit units of the display panel 210 are reduced as well. The timing controller 240 provides a polarity control signal POL, an activate signal STH, an odd/even control signal OEH, and a data signal DATA to the data driving unit 230. The timing controller 240 also controls gate lines, which are activated by the scan driving unit 220, according to the odd/even control signal OEH. The mentioned signals are to be described further.

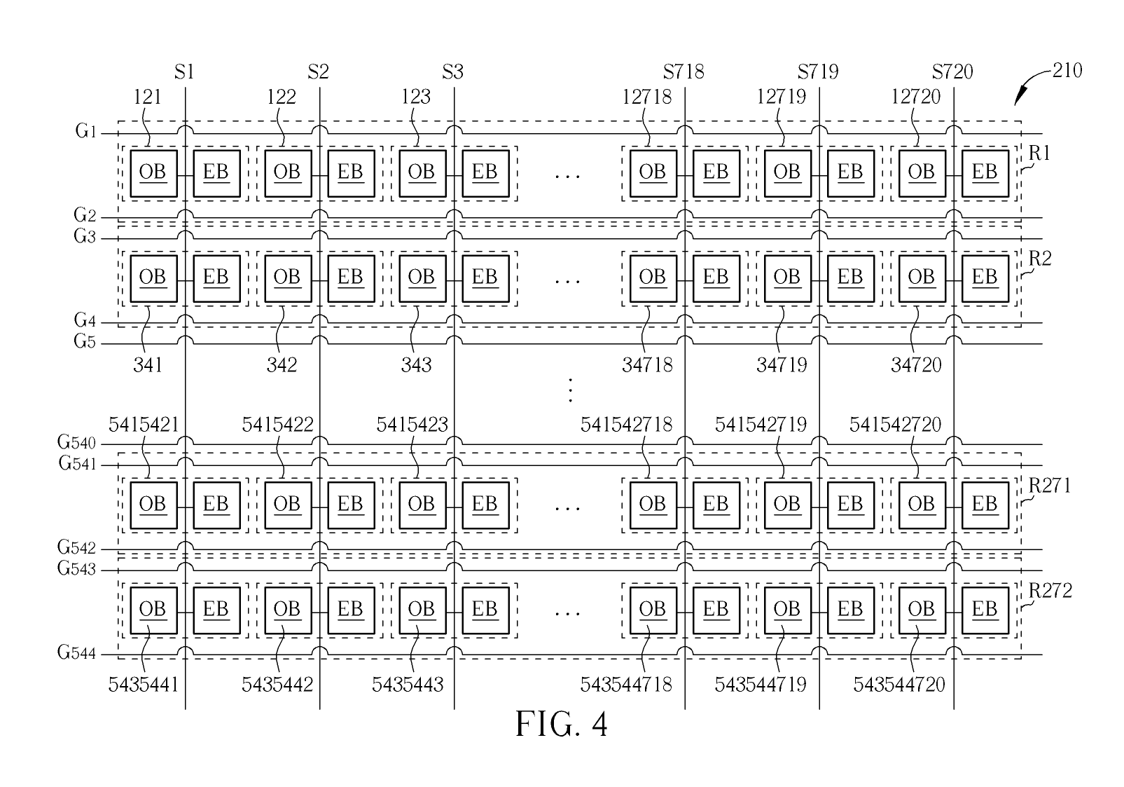

Please refer to FIG. 4, which is a diagram of the display panel 210 shown in FIG. 3 according to an embodiment of the present invention. As shown in FIG. 4, the display panel 210 includes a plurality of row transistor sets R1, R2, . . . , R271, and R272, which are arranged as a transistor matrix. Each of the plurality of row transistor sets is arranged in rows on the transistor matrix formed on the display panel 210. Each of the plurality of row transistor sets R1, R2, . . . , R271, and R272 includes a plurality of odd sub-pixel transistor modules OB and a plurality of even sub-pixel transistor modules EB. As can be observed from FIG. 4, in each row transistor set, the plurality of odd sub-pixel transistor modules OB are arranged in an alternative and respective correspondence with the plurality of even sub-pixel transistor modules EB. In a row transistor set, a pair of odd and even sub-pixel transistor modules, which are electrically connected to a same data line, may be regarded as a transistor unit. For example, in the row transistor set R1, the transistor unit 121 includes a pair of an odd sub-pixel transistor module OB and an even sub-pixel transistor module EB, which are electrically connected to a same data line S1 and are next to each other. Similarly, a pair of odd and even sub-pixel transistor modules OB and EB included by each of the transistor units 122, 123, 12718, 12719, 12720, 341, 342, 343, 34718, 34719, 34720, 5415421, 5415422, 5415423, 541542718, 541542719, 541542720, 5435441, 5435442, 5435443, 543544718, 543544719, 543544720 are electrically connected to a same data line and are next to each other. Note that though in each transistor unit shown in FIG. 4, the odd sub-pixel transistor module OB is disposed at a left side, and the even sub-pixel transistor module EB is disposed at a right side; in other embodiments of the present invention, the odd sub-pixel transistor module OB may be disposed at the right side, and the even sub-pixel transistor module EB may be disposed at the left side. Note that the transistor unit mentioned above just indicates a concept of electrically connecting a pair of neighboring odd and even sub-pixel transistor modules, and two gate lines corresponding to the pair of neighboring odd and even sub-pixel transistor modules may be exchanged mutually according to relative locations of the pair of neighboring odd and even sub-pixel transistor modules with respect to the transistor unit, so that FIG. 4 does not bring restrictions to the dispositions of the pair of neighboring odd and even sub-pixel transistor modules in a same transistor unit in embodiments of the present invention.

The gate lines G1, G3, G5, . . . , G541, and G543 are respectively and electrically connected to a plurality of odd sub-pixel transistor modules of each the row transistor set on the display panel 210, for respectively activating the plurality of odd sub-pixel transistor modules of each the row transistor set. A first gate line module may be regarded to include the gate lines G1, G3, G5, . . . , G541, and G543. Similarly, the gate lines G2, G4, G6, . . . , G542, and G544 are respectively and electrically connected to a plurality of even sub-pixel transistor modules of each the row transistor set on the display panel 210, for respectively activating the plurality of even sub-pixel transistor modules of each the row transistor set. A second gate line module may be regarded to include the gate lines G2, G4, G6, . . . , G542, and G544.

Each of the data lines S1, S2, S3, . . . , S718, S719, and s720 is arranged as a column of the transistor matrix formed on the display panel 210. Each of the data lines S1, S2, S3, . . . , S718, S719, and S720 is electrically connected to both an odd sub-pixel transistor module and an even sub-pixel transistor module of each of the row transistor sets R1, R2, . . . , R271, and R272.

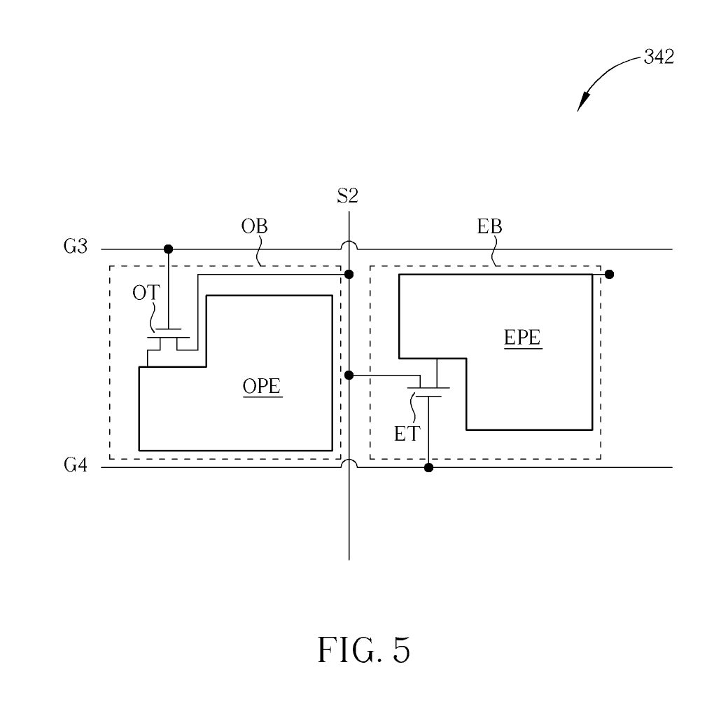

Please refer to FIG. 5, which is a diagram of a transistor unit of the display panel 210 shown in FIG. 4. Note that though merely the transistor 342 shown in FIG. 4 is illustrated in FIG. 5, it also indicates components or disposition of other transistor units shown in FIG. 4. As shown in FIG. 5, the transistor unit 342 includes an odd sub-pixel transistor module OB and an even sub-pixel transistor module EB. The odd sub-pixel transistor module OB includes an odd sub-pixel transistor OT and a pixel electrode OPE, which is electrically connected to the odd sub-pixel transistor OT. The even sub-pixel transistor module EB includes an even sub-pixel transistor ET and a pixel electrode EPE, which is electrically connected to the even sub-pixel transistor ET. The gate line G3 is electrically connected to the odd sub-pixel transistor module OB and the odd sub-pixel transistor OT, for controlling whether the odd sub-pixel transistor OT is activated. Similarly, the gate line G4 is electrically connected to the even sub-pixel transistor module EB and the even sub-pixel transistor ET, for controlling whether the even sub-pixel transistor ET is activated. The scan driving unit 220 is merely required to control an active time of the gate lines G3 and G4 so as to alternatively activate the odd sub-pixel transistor OT and the even sub-pixel transistor ET within a constant time interval. Therefore, a voltage on the data line S2 may be utilized for charging or discharging the pixel electrode OPE or EPE within the active time of the gate line G3 or G4.

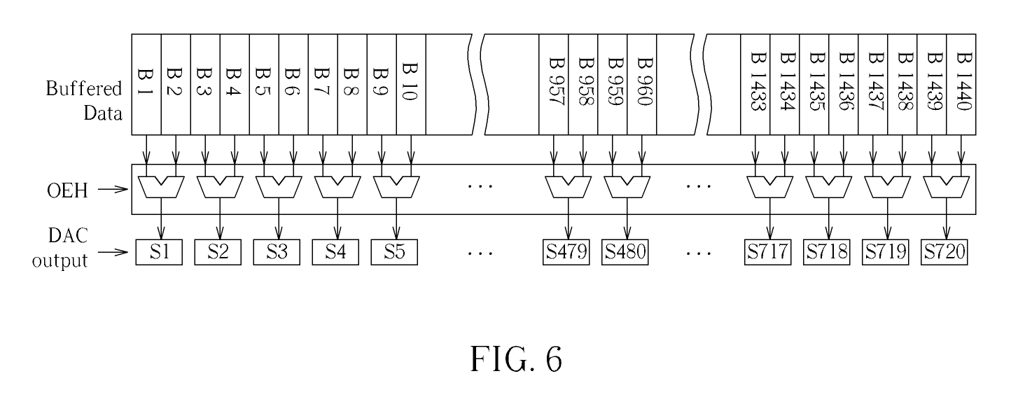

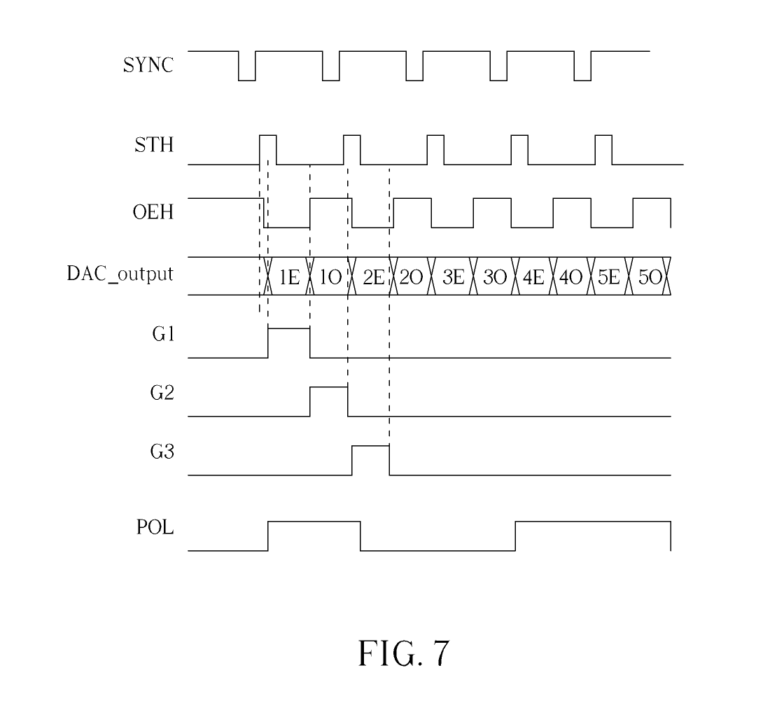

Please refer to FIG. 6 and FIG. 7. FIG. 6 illustrates data transfer on the display panel 210 shown in FIG. 3 and FIG. 4. FIG. 7 is a waveform diagram related to the display panel 210 shown in FIG. 3 and FIG. 4. FIG. 6 and FIG. 7 describe how transistors on the display panel 210 are controlled. The data driving unit 230 is assumed to have 1440 buffered data, which are indicated as B1, B2, . . . , B1440 in FIG. 6 and are generated according to a data signal DATA provided by the timing controller 240, at a certain moment. The buffered data B1, B2, . . . , B1440 are sequentially loaded on the data lines S1, S2, S3, . . . , S719, S720 according to the odd/even control signal OEH to generate a plurality of digital-to-analog signals DAC_output. Note that though the odd/even control signal OEH shown in FIG. 6 is implemented by multiplexers for selecting buffered data at different moments, in practical, the odd/even control signal OEH is not limited to be implemented by multiplexers. The synchronous signal SYNC shown in FIG. 7 is used by the timing controller 240. The activate signal STH is used for activating a procedure that each the transistor unit is activated by a corresponding gate line, where a time interval between two high pulses of the activate signal STH is corresponding to the activate time of a single transistor unit. The odd/even control signal OEH is used for determining both an order and a time interval of alternatively activating a pair of odd and even sub-pixel transistor modules included by the transistor unit while said transistor unit is activated. The digital-to-analog signal DAC_output is a voltage level on a data line corresponding to a single transistor while said transistor is activated, where the voltage level is utilized for indicating a gray level of a corresponding charged or discharged pixel electrode. While one of the gate lines G1, G2, G3, . . . , G544 is at a high voltage level, an odd sub-pixel transistor module or an even sub-pixel transistor module electrically connected to the gate line having the high voltage level is activated.

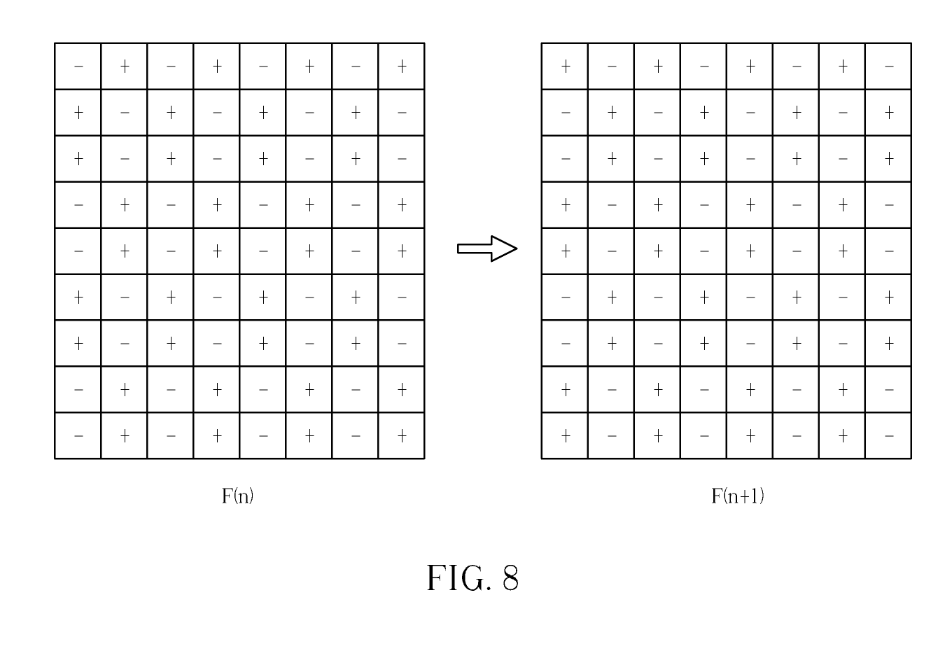

The polarity control signal POL is used for controlling the polarity inversion of a plurality of pixel electrodes of all odd and even sub-pixel transistor modules on the display panel 210. Please refer to FIG. 8, which illustrates the polarity inversion between two consecutively-displayed frames F(n) and F(n+1) in a correspondence to the waveform diagram shown in FIG. 7. FIG. 8 schematically illustrates polarity variations of odd data, which are indicated by odd pixels of a single frame, and even data, which are indicated by even pixels of the single frame, where the symbol “+” indicates a positive polarity, and the symbol “−” a negative polarity. As shown in FIG. 7, while the gate line G1 has a high voltage level, even sub-pixel transistors electrically connected to the gate line G1 are activated; at this time, the digital-to-analog signal DAC_output loads even data with positive polarities, as shown in FIG. 8. While the gate line G2 has a high voltage level, odd sub-pixel transistors electrically connected to the gate line G2 are activated; at this time, the digital-to-analog signal DAC_output loads odd data with negative polarities. Then while the gate line G3 has a high voltage level, even sub-pixel transistors electrically connected to the gate line G3 are activated, and at this time, the polarity control signal POL is changed from high to low so that the digital-to-analog signal DAC_output loads even data with negative polarities, as shown in FIG. 8. Similarly, while the gate line G4 has a high voltage level, odd sub-pixel transistors electrically connected to the gate line G4 are activated, and the digital-to-analog signal DAC_output loads odd data with positive polarities, as shown in FIG. 8. As conducted, a result of the above-mentioned polarities variations are shown in FIG. 8.

With the aid of controlling of the polarity control signal POL shown in FIG. 7, DC residue and crosstalk may be prevented, and power consumption and flickers may be reduced as a result.

As shown in FIG. 7, within an activate time, which is indicated by 1H in FIG. 7, of a single transistor unit activated by the activate signal STH, a high voltage level of the odd/even control signal OEH occupies half of the activate time 1H, whereas a low voltage level of the odd/even control signal OEH occupies half of the activate time 1H. While the odd/even control signal OEH has a high voltage level, odd sub-pixel transistor modules are activated according to activated gate lines, whereas while the odd/even control signal OEH has a low voltage level, even sub-pixel transistor modules are activated according to activated gate lines. Note that in other embodiments of the present invention, the high voltage level of the odd/even control signal OEH may also be used for activating even sub-pixel transistor modules, whereas the low voltage level of the odd/even control signal OEH may also be used for activating odd sub-pixel transistor modules, so that FIG. 7 does not form restrictions in using the odd/even control signal OEH. Besides, though in FIG. 7, within the activate time of a single transistor unit, the odd/even control signal OEH enters the low voltage level first and then enters the high voltage level, in other embodiments of the present invention, the odd/even control signal OEH may also enter the high voltage level first and then enters the low voltage level, so that FIG. 7 does not bring restrictions in a sequence of high/low voltage level of the odd/even control signal OEH. In brief, embodiments formed by changing correspondences between the odd/even control signal OEH and either one of the odd/even sub-pixel transistor modules and the high/low voltage level sequence according to possible combinations and permutations should be regarded as embodiments of the present invention.

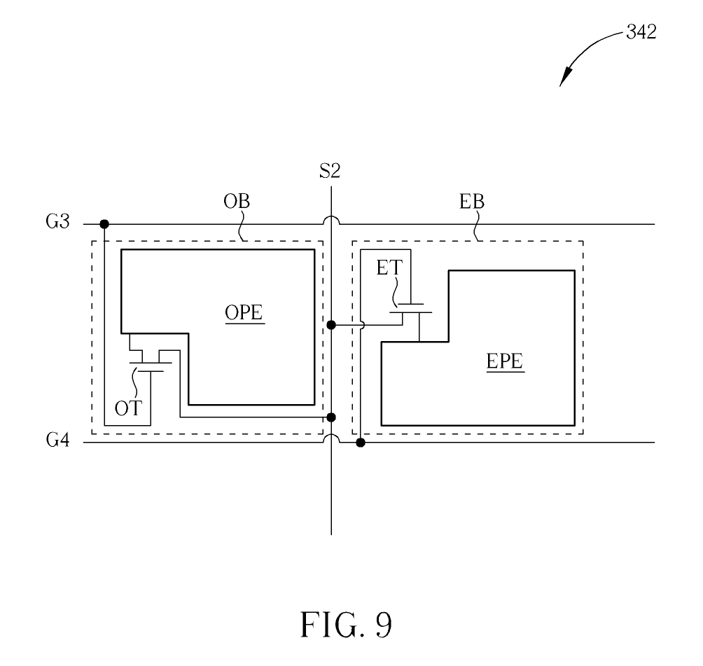

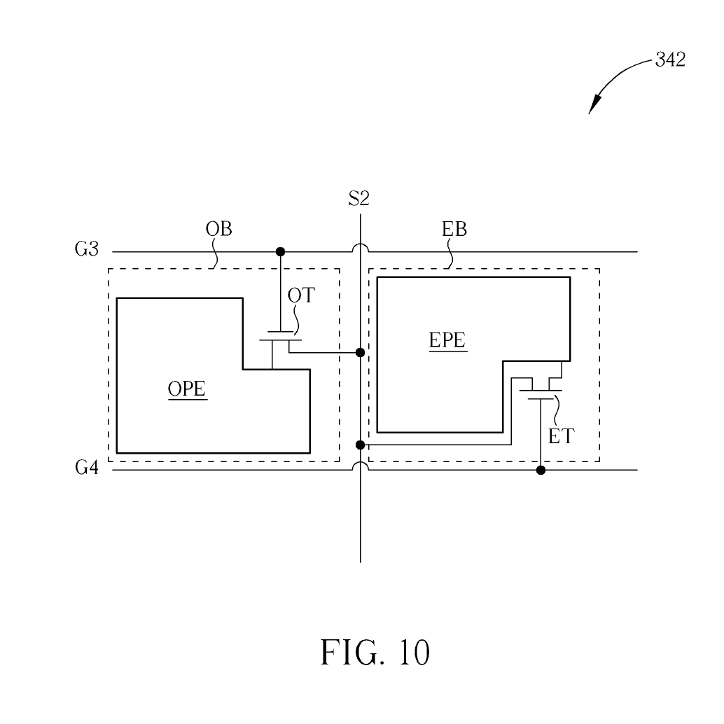

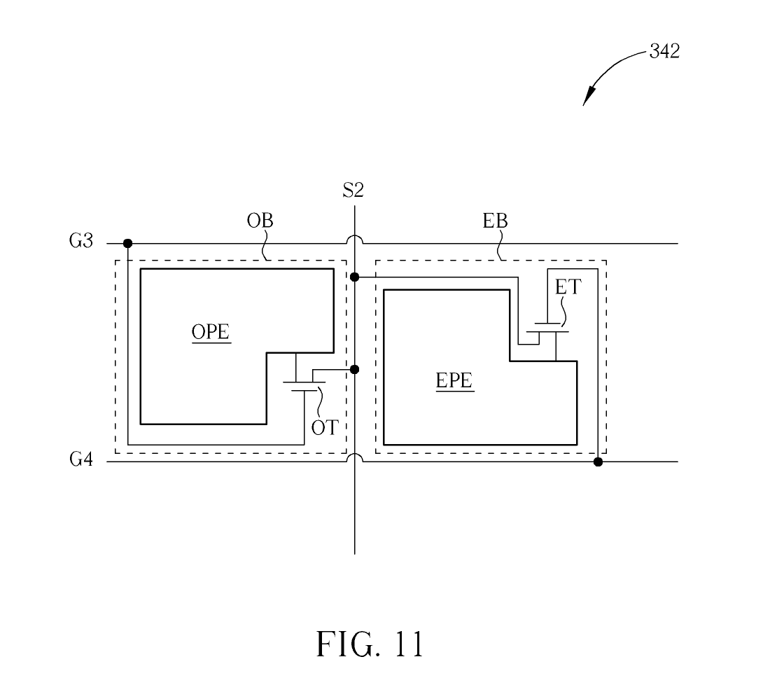

The disposition of the transistor unit shown in FIG. 5 effectively prevents the above-mentioned vertical lines. Since the odd sub-pixel transistor OT of the odd sub-pixel transistor module OB and the even sub-pixel transistor ET of the even sub-pixel transistor module EB are disposed in a mutually opposed and separated manner within the transistor unit, transmittance of both the sub-pixel transistors OT and ET are uniformed distributed so that there are no vertical lines on the display panel 210. For example, as shown in FIG. 5, the odd sub-pixel transistor OT located at a northwest corner of the odd sub-pixel transistor module OB and the even sub-pixel transistor ET located at a southwest corner of the even sub-pixel transistor module EB just indicate a mutually opposed and separated disposition within the transistor unit. Note that if the odd sub-pixel transistor OT shown in FIG. 5 is changed to be disposed at other locations on the odd sub-pixel transistor module OB, transmittance of the odd and even sub-pixel transistor module OB and EB will be over-concentrated so that vertical lines are brought on the display panel 210. Please refer to FIG. 9, FIG. 10, and FIG. 11, which are diagrams of transistor units used on the display panel of the present invention for preventing the vertical lines according to embodiments of the present invention. In FIG. 9, the odd sub-pixel transistor OT is disposed at a southwest corner of the odd sub-pixel transistor module OB, and the even sub-pixel transistor ET is disposed at a northwest corner of the even sub-pixel transistor module EB. In FIG. 10, the odd sub-pixel transistor OT is disposed at a northeast corner of the odd sub-pixel transistor module OB, and the even sub-pixel transistor ET is disposed at a southeast corner of the even sub-pixel transistor module EB. In FIG. 11, the odd sub-pixel transistor OT is disposed at a southeast corner of the odd sub-pixel transistor module OB, and the even sub-pixel transistor ET is disposed at a northeast corner of the even sub-pixel transistor module EB. The sub-pixel transistors OT and ET shown in FIG. 9, FIG. 10, and FIG. 11 are disposed in a mutually opposed and separated manner within the transistor units as well, for balancing transmittance of the transistor units within or related to other neighboring transistor units so as to prevent vertical lines on the display panel 210.

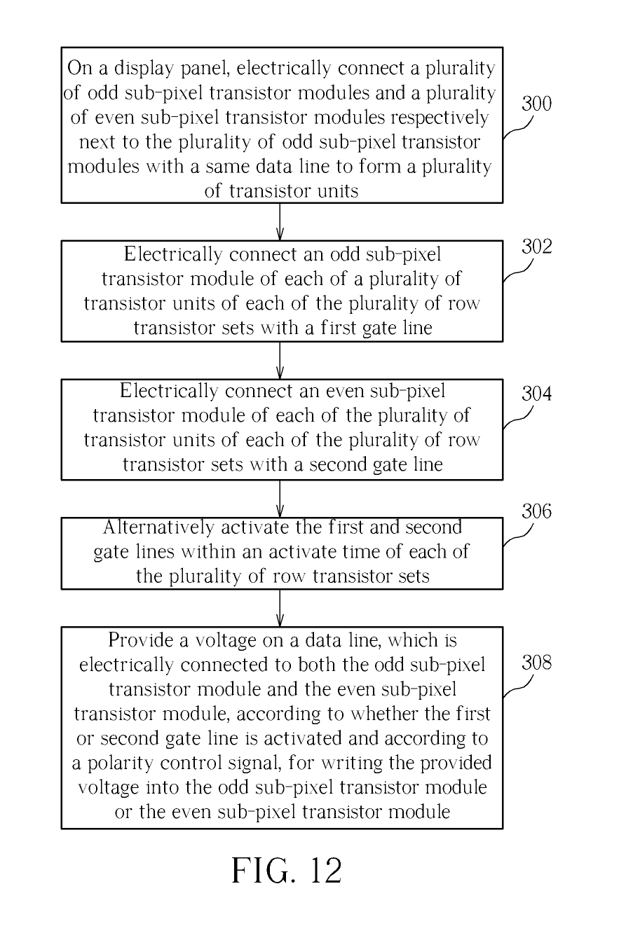

Please refer to FIG. 12, which is a flowchart of a method of reducing data lines on a display panel according to an embodiment of the present invention. Steps mentioned in FIG. 12 indicate a summary of the descriptions from FIG. 3 to FIG. 11 so that further explanations are saved for brevity. As shown in FIG. 12, the method of the present invention includes steps as follows:

Step 300: On a display panel, electrically connect a plurality of odd sub-pixel transistor modules and a plurality of even sub-pixel transistor modules respectively next to the plurality of odd sub-pixel transistor modules with a same data line to form a plurality of transistor units;

Step 302: Electrically connect an odd sub-pixel transistor module of each of a plurality of transistor units of each of the plurality of row transistor sets with a first gate line;

Step 304: Electrically connect an even sub-pixel transistor module of each of the plurality of transistor units of each of the plurality of row transistor sets with a second gate line;

Step 306: Alternatively activate the first and second gate lines within an activate time of each of the plurality of row transistor sets; and

Step 308: Provide a voltage on a data line, which is electrically connected to both the odd sub-pixel transistor module and the even sub-pixel transistor module, according to whether the first or second gate line is activated and according to a polarity control signal, for writing the provided voltage into the odd sub-pixel transistor module or the even sub-pixel transistor module.

The flowchart shown in FIG. 12 merely indicates a preferred embodiment of the present invention. Embodiments formed by adding restrictions mentioned above or performing available combinations or permutations on the flowchart shown in FIG. 12 should also be regarded as embodiments of the present invention.

The present invention discloses a display panel of reducing used data lines, a liquid crystal display module including the disclosed display panel, and a method thereof. In the disclosed display panel and method of the present invention, two neighboring sub-pixel transistor modules of each row transistor set are electrically connected to a same data line so that used data lines of the display panel are halved. Though used gate lines of the display panel are doubled as a price, since data lines are much more than gate lines in a conventional display panel, as a result, total lines used on the display panel of the present invention are still reduced significantly. In the display panel and method disclosed in the present invention, the voltage on each data lines is controlled by a polarity control signal so as to perform polarity inversion, for prevent DC residue and crosstalk, and for reduce power consumption and flickers. Besides, two sub-pixel transistors of each transistor unit included by the disclosed display panel are disposed in a mutually opposed and separated manner for preventing concentrated transmittance of the sub-pixel transistors and vertical lines on the display panel.

Those skilled in the art will readily observe that numerous modifications and alterations of the device and method may be made while retaining the teachings of the invention.

What is claimed is:

1. A display panel, comprising:
a plurality of row transistor sets arranged as a transistor matrix, each of the plurality of row transistor sets being disposed on the transistor matrix row by row, each of the plurality of row transistor sets comprising:
a plurality of odd sub-pixel transistor modules; and
a plurality of even sub-pixel transistor modules arranged in an alternative and respective correspondence with the plurality of odd-pixel transistor modules;
a first gate line module comprising a plurality of first gate lines, each of the plurality of first gate lines being respectively corresponding to the plurality of row transistor sets, and each of the plurality of first gate lines being electrically connected to a plurality of odd sub-pixel transistor modules comprised by one of the plurality of row transistor sets;
a second gate line module comprising a plurality of second gate lines, each of the plurality of second gate lines being respectively corresponding to the plurality of row transistor sets, and each of the plurality of second gate lines being electrically connected to a plurality of even sub-pixel transistor modules comprised by one of the plurality of row transistor sets; and
a plurality of data lines, each of the plurality of data lines being electrically connected to both an odd sub-pixel transistor module and an even sub-pixel transistor module of each of the plurality of row transistor sets;
wherein the odd and even sub-pixel transistor modules electrically connected to each of the plurality of data lines in a same row transistor module are next to each other to form a transistor unit.

2. The display panel of claim 1,
wherein in each of the plurality of row transistor sets, each of the plurality of odd sub-pixel transistor module comprises:
an odd sub-pixel transistor; and
a first pixel electrode electrically connected to the odd sub-pixel transistor;
wherein in each of the plurality of row transistor sets, each of the plurality of even sub-pixel transistor module comprises:
an even sub-pixel transistor; and
a second pixel electrode electrically connected to the even sub-pixel transistor.

3. The display panel of claim 2,
wherein in the transistor unit, the odd sub-pixel transistor, which is comprised by the odd sub-pixel transistor module, and the even sub-pixel transistor, which is comprised by the even sub-pixel transistor module, are disposed in a mutually opposed and separated manner.

4. The display panel of claim 3,
wherein the odd sub-pixel transistor module is disposed at a left side of the transistor unit, and the even sub-pixel transistor module is disposed at a right side of the transistor unit;
wherein the odd sub-pixel transistor is disposed at a northwest corner of the odd sub-pixel transistor module;
wherein the even sub-pixel transistor is disposed at a southwest corner of the even sub-pixel transistor module.

5. The display panel of claim 3,
wherein the odd sub-pixel transistor module is disposed at a left side of the transistor unit, and the even sub-pixel transistor module is disposed at a right side of the transistor unit;
wherein the odd sub-pixel transistor is disposed at a southwest corner of the odd sub-pixel transistor module;
wherein the even sub-pixel transistor is disposed at a northwest corner of the even sub-pixel transistor module.

6. The display panel of claim 3,
wherein the odd sub-pixel transistor module is disposed at a left side of the transistor unit, and the even sub-pixel transistor module is disposed at a right side of the transistor unit;
wherein the odd sub-pixel transistor is disposed at a northeast corner of the odd sub-pixel transistor module;
wherein the even sub-pixel transistor is disposed at a southeast corner of the even sub-pixel transistor module.

7. The display panel of claim 3,
wherein the odd sub-pixel transistor module is disposed at a left side of the transistor unit, and the even sub-pixel transistor module is disposed at a right side of the transistor unit;
wherein the odd sub-pixel transistor is disposed at a southeast corner of the odd sub-pixel transistor module;
wherein the even sub-pixel transistor is disposed at a northeast corner of the even sub-pixel transistor module.

8. The display panel of claim 1,
wherein a data driving unit is electrically connected to the plurality of data lines, and a scan driving unit is electrically connected to both the first gate line module and the second gate line module;
wherein the scan driving unit activates the first and second gate line modules in an alternative manner, for alternatively driving the plurality of odd and even sub-pixel transistor modules of each of the plurality of row transistor sets;
wherein the data driving unit determines output gray levels of the plurality of odd and even sub-pixel transistor modules according to a data signal, and performs polarity inversion according to a polarity control signal.

9. A method of reducing data lines used on a display panel, comprising:
electrically connecting a plurality of odd sub-pixel transistor modules and a plurality of even sub-pixel transistor modules respectively next to the plurality of odd sub-pixel transistor modules with a same data line to form a plurality of transistor units, the plurality of odd and even sub-pixel transistor modules being comprised by each of a plurality of row transistor sets;
electrically connecting an odd sub-pixel transistor module of each of a plurality of transistor units of each of the plurality of row transistor sets with a first gate line;
electrically connecting an even sub-pixel transistor module of each of the plurality of transistor units of each of the plurality of row transistor sets with a second gate line;
alternatively activating the first and second gate lines within an activate time of each of the plurality of row transistor sets; and
providing a voltage on a data line, which is electrically connected to both the odd sub-pixel transistor module and the even sub-pixel transistor module, according to whether the first or second gate line is activated and according to a polarity control signal, for writing the provided voltage into the odd sub-pixel transistor module or the even sub-pixel transistor module.

10. The method of claim 9,
wherein the odd sub-pixel transistor module comprises:
an odd sub-pixel transistor; and
a first pixel electrode electrically connected to the odd sub-pixel transistor;
wherein the even sub-pixel transistor module comprises:
an even sub-pixel transistor; and
a second pixel electrode electrically connected to the even sub-pixel transistor;
wherein alternatively activating the first and second gate lines within the activate time of each of the plurality of row transistor sets comprises:
alternatively activating the odd sub-pixel transistor and the even sub-pixel transistor;
wherein providing the voltage on the data line comprises:
writing the voltage into the first pixel electrode or the second pixel electrode.

11. The method of claim 10, wherein in the transistor unit, the odd sub-pixel transistor, which is comprised by the odd sub-pixel transistor module, and the even sub-pixel transistor, which is comprised by the even sub-pixel transistor module, are disposed in a mutually opposed and separated manner.

12. The method of claim 11,
wherein the odd sub-pixel transistor module is disposed at a left side of the transistor unit, and the even sub-pixel transistor module is disposed at a right side of the transistor unit;
wherein the odd sub-pixel transistor is disposed at a northwest corner of the odd sub-pixel transistor module;
wherein the even sub-pixel transistor is disposed at a southwest corner of the even sub-pixel transistor module.

13. The method of claim 11,
wherein the odd sub-pixel transistor module is disposed at a left side of the transistor unit, and the even sub-pixel transistor module is disposed at a right side of the transistor unit;
wherein the odd sub-pixel transistor is disposed at a southwest corner of the odd sub-pixel transistor module;
wherein the even sub-pixel transistor is disposed at a northwest corner of the even sub-pixel transistor module.

14. The method of claim 11,
wherein the odd sub-pixel transistor module is disposed at a left side of the transistor unit, and the even sub-pixel transistor module is disposed at a right side of the transistor unit;
wherein the odd sub-pixel transistor is disposed at a northeast corner of the odd sub-pixel transistor module;
wherein the even sub-pixel transistor is disposed at a southeast corner of the even sub-pixel transistor module.

15. The method of claim 11,
wherein the odd sub-pixel transistor module is disposed at a left side of the transistor unit, and the even sub-pixel transistor module is disposed at a right side of the transistor unit;
wherein the odd sub-pixel transistor is disposed at a southeast corner of the odd sub-pixel transistor module;
wherein the even sub-pixel transistor is disposed at a northeast corner of the even sub-pixel transistor module.

16. The method of claim 9,
wherein alternatively activating the first and second gate lines within the activate time of each of the plurality of row transistor sets comprises:
a scan driving unit alternatively activating the first and second gate lines;
wherein providing the voltage on the data line comprises:
a data driving unit providing the voltage on the data line according to whether the first or second gate line is activated and according to the polarity control signal.

17. A liquid crystal display module, comprising:
a display panel, comprising:
a plurality of row transistor sets arranged as a transistor matrix, each of the plurality of row transistor sets being disposed on the transistor matrix row by row, each of the plurality of row transistor sets comprising:
a plurality of odd sub-pixel transistor modules; and
a plurality of even sub-pixel transistor modules arranged in an alternative and respective correspondence with the plurality of odd-pixel transistor modules;
a first gate line module comprising a plurality of first gate lines, each of the plurality of first gate lines being respectively corresponding to the plurality of row transistor sets, and each of the plurality of first gate lines being electrically connected to a plurality of odd sub-pixel transistor modules comprised by one of the plurality of row transistor sets;
a second gate line module comprising a plurality of second gate lines, each of the plurality of second gate lines being respectively corresponding to the plurality of row transistor sets, and each of the plurality of second gate lines being electrically connected to a plurality of even sub-pixel transistor modules comprised by one of the plurality of row transistor sets; and
a plurality of data lines, each of the plurality of data lines being electrically connected to both an odd sub-pixel transistor module and an even sub-pixel transistor module of each of the plurality of row transistor sets;
a scan driving unit electrically connected to the first gate line module and the second gate line module, the scan driving unit being utilized for alternatively activating the first and second gate line modules, for alternatively driving the plurality of odd and even sub-pixel transistor modules of each of the row transistor sets and for performing polarity inversion; and
a data driving unit electrically connected to the plurality of data lines, the data driving unit provides a voltage according to whether the first or second gate line is activated and according to a polarity control signal, for writing the provided voltage into the odd sub-pixel transistor module or the even sub-pixel transistor module to perform polarity inversion.

18. The liquid crystal display module of claim 17, further comprising:
a timing controller, for providing a data signal, the polarity control signal, an activate signal, and an odd/even control signal to the data driving unit, and for determining gate lines activated by the scan driving unit according to the odd/even control signal;
wherein in each of the plurality of transistor units, the data signal is used for controlling gray levels used by the odd sub-pixel transistor module or the even sub-pixel transistor module, and the activate signal is used for activating a procedure that each of the plurality of transistor units is activated by a corresponding gate line;
wherein the scan driving unit alternatively activates the first gate line module and the second gate line module according to the odd/even control signal, for alternatively driving the plurality of odd sub-pixel transistor module and the plurality of even sub-pixel transistor module of each of the plurality of row transistor sets.

19. The liquid crystal display module of claim 17,
wherein in each of the plurality of row transistor sets, each of the plurality of odd sub-pixel transistor module comprises:
an odd sub-pixel transistor; and
a first pixel electrode electrically connected to the odd sub-pixel transistor;
wherein in each of the plurality of row transistor sets, each of the plurality of even sub-pixel transistor module comprises:
an even sub-pixel transistor; and
a second pixel electrode electrically connected to the even sub-pixel transistor.

20. The liquid crystal display module of claim 19,
wherein in the transistor unit, the odd sub-pixel transistor, which is comprised by the odd sub-pixel transistor module, and the even sub-pixel transistor, which is comprised by the even sub-pixel transistor module, are disposed in a mutually opposed and separated manner.

21. The liquid crystal display module of claim 20,
wherein the odd sub-pixel transistor module is disposed at a left side of the transistor unit, and the even sub-pixel transistor module is disposed at a right side of the transistor unit;
wherein the odd sub-pixel transistor is disposed at a northwest corner of the odd sub-pixel transistor module;
wherein the even sub-pixel transistor is disposed at a southwest corner of the even sub-pixel transistor module.

22. The liquid crystal display module of claim 20,
wherein the odd sub-pixel transistor module is disposed at a left side of the transistor unit, and the even sub-pixel transistor module is disposed at a right side of the transistor unit;
wherein the odd sub-pixel transistor is disposed at a southwest corner of the odd sub-pixel transistor module;
wherein the even sub-pixel transistor is disposed at a northwest corner of the even sub-pixel transistor module.

23. The liquid crystal display module of claim 20,
wherein the odd sub-pixel transistor module is disposed at a left side of the transistor unit, and the even sub-pixel transistor module is disposed at a right side of the transistor unit;
wherein the odd sub-pixel transistor is disposed at a northeast corner of the odd sub-pixel transistor module;
wherein the even sub-pixel transistor is disposed at a southeast corner of the even sub-pixel transistor module.

24. The liquid crystal display module of claim 20,
wherein the odd sub-pixel transistor module is disposed at a left side of the transistor unit, and the even sub-pixel transistor module is disposed at a right side of the transistor unit;
wherein the odd sub-pixel transistor is disposed at a southeast corner of the odd sub-pixel transistor module;
wherein the even sub-pixel transistor is disposed at a northeast corner of the even sub-pixel transistor module.
